(19) United States
(12) Patent Application Publication
(10) Pub. No.: US 2002/0025779 A1
(43) Pub. Date: Feb. 28, 2002

(54) Wireless communications methods and systems using a remote, self-contained cell site

(76) Inventors: Clifford Lee Knight, Cape Coral, FL (US); Myles O'Reilly, Palm City, FL (US); Myrle Kenneth Wiekert, Lake Mary, FL (US)

Correspondence Address: John Pratt, Esq., Kilpatrick Stockton LLP, Suite 2800, 100 Peachtree Street, Atlanta, GA, 30309-4530, US

(21) Appl. No.: 09/752,336

(22) Filed: Dec. 29, 2000

Related U.S. Application Data
(60) Provisional application No. 60/228,244, filed on Aug. 25, 2000.

(51) Int. Cl. H04B 7/15

(52) U.S. Cl. 455/11.1; 455/7; 370/315; 375/211

(57) ABSTRACT

This invention provides wireless communications using a remote, self-contained cell site that transceives signals from wireless personal communication devices and communicates these signals with a cellular system connected to a communications network. In an exemplary embodiment, the remote, self-contained cell site is a mobile cellular system that includes a transportation vehicle that carries a radio frequency unit, a modem, a multiplexer/demultiplexer, a digital and/or analog signal processing unit, a loop-back circuit, a control unit, a database, a microwave radio, a radio frequency radio, an extendible mast that supports a microwave antenna, an extendible mast that supports a radio frequency antenna, a generator, an air conditioner, and backup batteries.

### PRIORITY APPLICATION

This application claims priority to co-pending U.S. Provisional Application No. 60/169,982 filed Aug. 25, 2000, entitled “Wireless Communications Methods and Systems Using Remote, Self-Contained Communications Devices,” which is fully incorporated herein by reference.

### CROSS REFERENCE TO RELATED APPLICATIONS

This application relates to applicant's co-pending Attorney Docket Number 36968-206125 application filed simultaneously herewith, entitled “Wireless Communications Methods And Systems Using A Remote, Self-Contained Communications Antenna Unit” which is fully incorporated herein by reference.

### COPYRIGHT NOTIFICATION

A portion of the disclosure of this patent document and its figures contain material that is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND OF THE INVENTION

1. Field of the Invention

This invention relates generally to the field of wireless communications. More particularly, this invention relates to wireless communication methods and systems for wireless personal communication devices and for interconnecting these wireless personal communication devices over a linking frequency using a remote, self-contained cell site.

2. Background

Wireless communication networks comprise one or more cell sites that assign radio channels for connecting a wireless personal communication device, such as, for example, a cellular telephone, to another telephone (wireless or wired) through a cellular switch connected to a terrestrial telephone network. Wireless communication networks typically include a plurality of interconnected (wireless or wired) cell sites that are coupled with a centrally located cellular switch, called a Mobile Telephone Switching Office (MTSO), and that connect to a communications network. Cell sites are essentially buildings that house equipment for transmitting, receiving, and processing wireless communications to the communications network. There are typically fifty to one hundred cell sites in large cities, fifteen to fifty cell sites in smaller cities, and very few cell sites or none in rural areas. Depending on capacity constraints, cell sites may be located one-half to twenty miles from each other. Further, each cell site generally comprises one or more stationary antennas mounted on a triangular platform that is placed on a tower or atop a tall building preferably sixty to three hundred feet above the surrounding terrain.

Conventional installation of a new cell site requires placement of one or more antennas and construction of a cable transmission path for a wired connection (e.g., use of a T1) of the cell site to a switching system. The cost associated with installing a new cell site is very substantial and ranges on the average from several hundred thousand to half a million dollars. Additionally, actual siting may not be available for a variety of reasons, such as unavailability of the sector for the physical plant that contains the cell site, terrain restraints, regulatory restraints, and the like.

When the wired connection is lost to a conventional cell site, the cell site is disconnected and goes “off the air.” Wireless personal communication devices serviced by the disconnected cell site cannot transmit or receive signals (i.e., a customer cannot place or receive a telephone call). Depending on the nature of the trouble, the cell site could be off the air for an extended period of time. Loss of revenue to the cellular provider and customer inconvenience result until the wired connection is repaired and restored. While there are techniques known in the art that provide emergency means in case of a line fault, they: (1) are bulky and difficult to readily implement; (2) are expensive; and (3) have a limit in the number of applicable connections and in the applicable status of a connection.

Thus, replacement methods and systems are needed to provide easy, affordable, and flexible remote wireless communications with wireless personal communication devices and to connect these devices to a communications network using a remote, self-contained communications antenna unit and a remote, self-contained cell site.

### SUMMARY OF THE INVENTION

This invention provides wireless communications using a remote, self-contained cell site that transceives signals from wireless personal communication devices and communicates these signals to a cellular system connected to a communications network. As used herein, a “communications network” includes terrestrial communications networks, such as, for example, the public switch telephone network, as well as celestial communications networks. Further, as used herein, the term “transceive” includes transmitting, receiving, and processing communication signals. In one embodiment, the cellular system is a conventional cell site base station (i.e., a building with cellular transceiving equipment) connected to a cellular switch, such as, for example, a MTSO, connected to a terrestrial telephone network, such as, for example, the Public Switch Telephone Network (PSTN). In another embodiment, the cellular system is a remote, self-contained communications antenna unit coupled with either a conventional cell site base station or a crossbox junction point.

The remote, self-contained cell site is a mobile cell site that includes small-scaled hardware components of a conventional cell site base station, including, for example, antennas for communicating with the cellular switch and for communicating with wireless personal communication devices. The remote, self-contained cell site includes a power source, backup power source, transceiving equipment, a signal processor, network communications equipment, two antennas, and an antenna mast for supporting the antenna to transceive wireless communications at various heights. Further, the remote, self-contained cell site may be mounted upon a transportation vehicle.

In a preferred embodiment, the remote, self-contained cell site is a light truck that transports and carries a generator, a radio frequency unit, a modem, a multiplexer/demultiplexer, a signal processing unit, a loop back circuit, a control unit, a database, a microwave radio, a radios frequency radio, backup batteries, an air conditioner, a microwave dish antenna, a radio frequency antenna, and an extendible mast that supports the microwave dish antenna and the radio frequency antenna. The remote, self-contained cell site also includes a power charging unit that charges the power source, the backup power source, and the truck.

The remote, self-contained cell site can use a variety of types of transmission and receiving equipment to transmit and receive signals over numerous frequencies and may include a duplex transceiver to provides a means for sending and receiving signals at a linking frequency. Further, this invention may communicate with the communications network using radio frequency link from the remote, self-contained cell site to the cellular system, such as a remote, self-contained communications antenna unit connected to a crossbox.

The remote, self-contained cell site has the appearance of a conventional operational cell site base station to the wireless communications network. The remote, self-contained cell site provides a rapid, inexpensive, and efficient method and system to transceive communication signals (e.g., the Industrial, Scientific, and Medical (ISM) Band frequencies, such as, 2.4-2.5 GHz, cellular telephone frequencies, such as, 806-960 MHz, 1710-1855 MHz, and 2500-2690 MHz, paging frequencies, digital processing frequencies, and any other frequency in the electromagnetic spectrum) from wireless personal communication devices and to connect these wireless personal communication devices with the communications network. Further, this invention is easily located at a variety of locations because of the highly mobile platforms that carry the remote, self-contained cell site.

This invention is useful for restoring cell site functionality, for providing emergency service, for increasing cellular capacity, and for adding a remote, self-contained cell site when a conventional cell site is not feasible. For instance, the remote, self-contained cell site provides cellular service where a line fault has disconnected the conventional cell site and caused it to go “off the air” (e.g., the T1 connection to the terrestrial telephone network has been cut). It provides service to a location out of range of cell sites, such as, service to a rural location. This invention is also useful for temporarily increasing cellular capacity, such as, for example, providing cellular coverage to customers attending large events like the SuperBowl and the Olympics. Further, this invention is useful for adding a permanent cell site when laying a transmission path to a switching system is difficult or impossible or when adding a permanent cell site is too costly.

These uses may be accomplished singularly, or in combination, in one or more of the embodiments of this invention.

Additional uses, objects, advantages, and novel features of the invention are set forth in the detailed description that follows and will become more apparent to those skilled in the art upon examination of the following or by practice of the invention.

### BRIEF DESCRIPTION OF THE FIGURES

Other objects, advantages, and novel features of this invention are more clearly understood by reference to the following and the accompanying figures, in which:

FIG. 1 illustrates the communications paths using the remote, self-contained cell site of this invention and the remote, self-contained communication antenna unit connected to the communications network through a conventional cell site base station.

FIG. 2 illustrates the communications paths using the remote, self-contained cell site and the remote, self-contained communication antenna unit shown in FIG. 1, with the remote, self- contained communications antenna unit connected to the communications network through a crossbox junction point.

FIG. 3 is a more detailed schematic diagram of the remote, self-contained cell site shown in FIGS. 1 and 2.

### DETAILED DESCRIPTION

The following is presented by way of example and should not be construed as limiting the inventive concept to any particular configuration.

In conventional wireless communications networks, a plurality of interconnected switching systems are coupled with a plurality of cell sites that transmit and receive signals to wireless personal communication devices. The remote, self-contained cell site of this invention allows wireless communication service providers to rapidly, inexpensively, and efficiently provide wireless communication coverage to restore conventional cell site functionality, to provide emergency service, to increase cellular capacity, or to add a remote, self-contained cell site when a conventional cell site is not feasible.

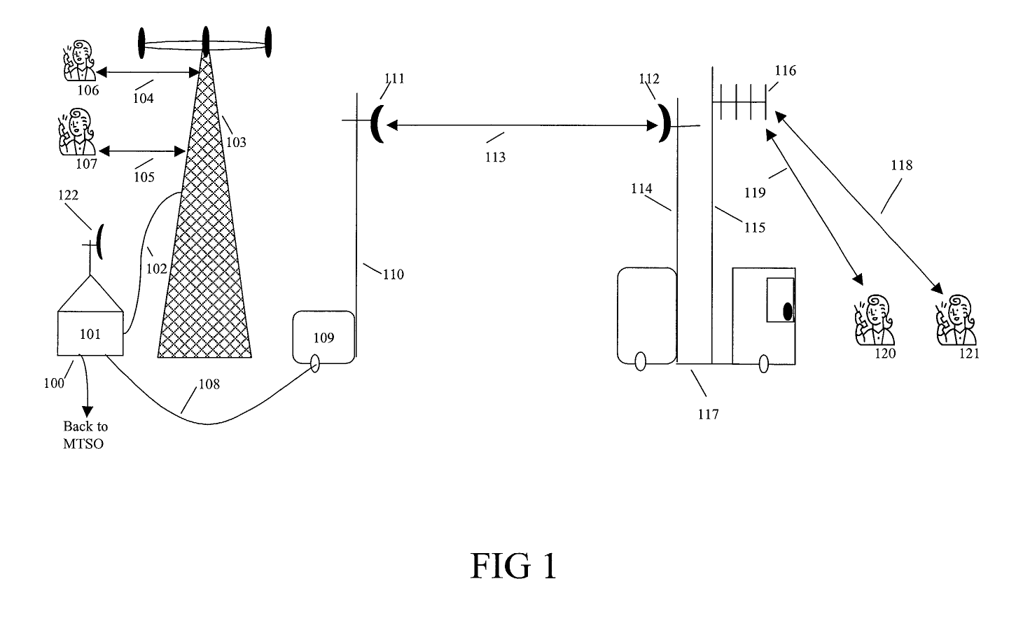

FIG. 1 depicts the communications paths using a remote, self-contained cell site 117 and using a remote, self-contained communication antenna unit 109 connected to the communications network through a conventional cell site base station 101. The conventional cell site base station (“cell site”) 101 connects wireless personal devices 106, 107 with the communications network. Cell site 101 is coupled to an antenna 103 using a wired medium 102. The cell site 101 is said to be “on the air” when it is connected to a switching system of the communications network, such as the MTSO, over a wired medium 100. Cell site 101 is capable of transceiving signals 104, 105 with a plurality of wireless personal communication devices 106, 107 and is capable of communicating signals 104, 105 over the communications network.

Cell site 101 is connected to a remote, self-contained communications antenna unit 109 using a wired medium 108, such as a T1 connection. Alternatively, wireless communications could be used to establish a connection between the cell site 101 and the remote, self-contained communications antenna unit 109. For example (and contrary to what is depicted in FIG. 1), a microwave antenna 111 supported by the mast 110 of the remote, self-contained communications antenna unit 109 could transceive microwave signals to a microwave antenna 122 of cell site 101.

FIG. 1 depicts the remote, self-contained communications antenna unit 109 including a microwave antenna 111 that communicates wireless signals with a microwave antenna 112 of the remote, self-contained cell site 117 on a linking frequency signal 113. The remote, self-contained cell site 117 provides a means to establish wireless communications between the communications network and with wireless personal communication devices 120, 121. For example, an radio frequency antenna 116 supported by a mast 115 of the remote, self-contained cell site transceives signals 118, 119 from wireless personal devices 120, 121. The remote, self-contained cell site processes and connects signals 118, 119 to the communications network using a microwave antenna 112 supported by mast 114.

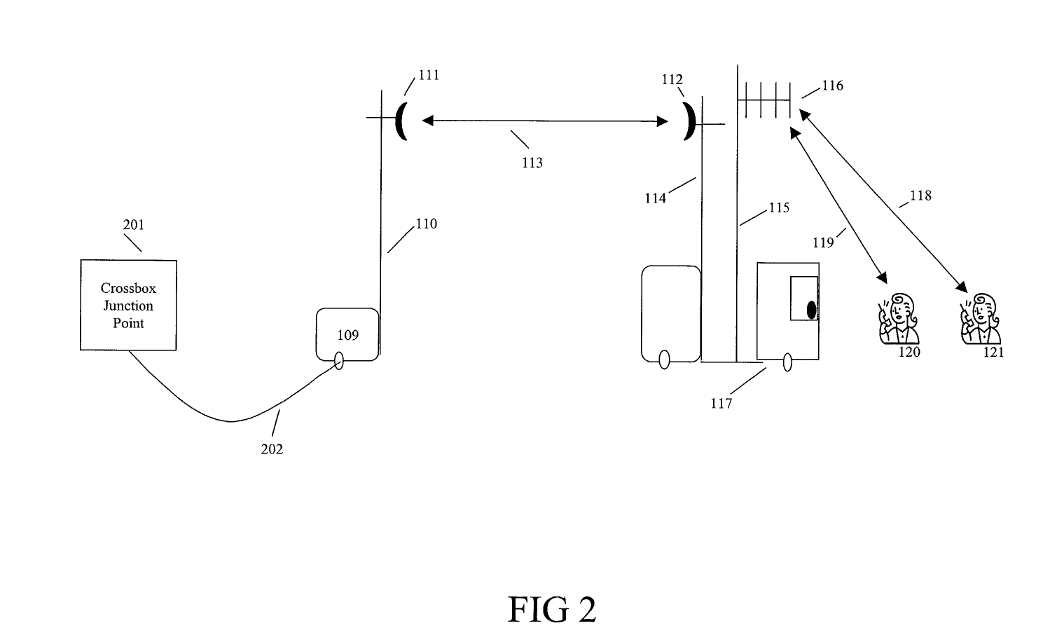

FIG. 2 depicts communications paths using the remote, self-contained cell site 117 connected to the communications network by a remote, self-contained communication antenna unit 109 coupled with a local service provider's crossbox junction point 201. Communication signals 118, 119 from wireless personal devices 120, 121 are processed by the remote, self-contained cell site 117 and communicated to the communications network using a microwave antenna 112 supported by mast 114. These signals are sent to antenna 111 of the remote, self-contained communications antenna unit 109 on a linking frequency signal 113. The remote, self-contained antenna unit 109 is coupled to the communications network using a wired medium 202 connected to the crossbox junction point 201.

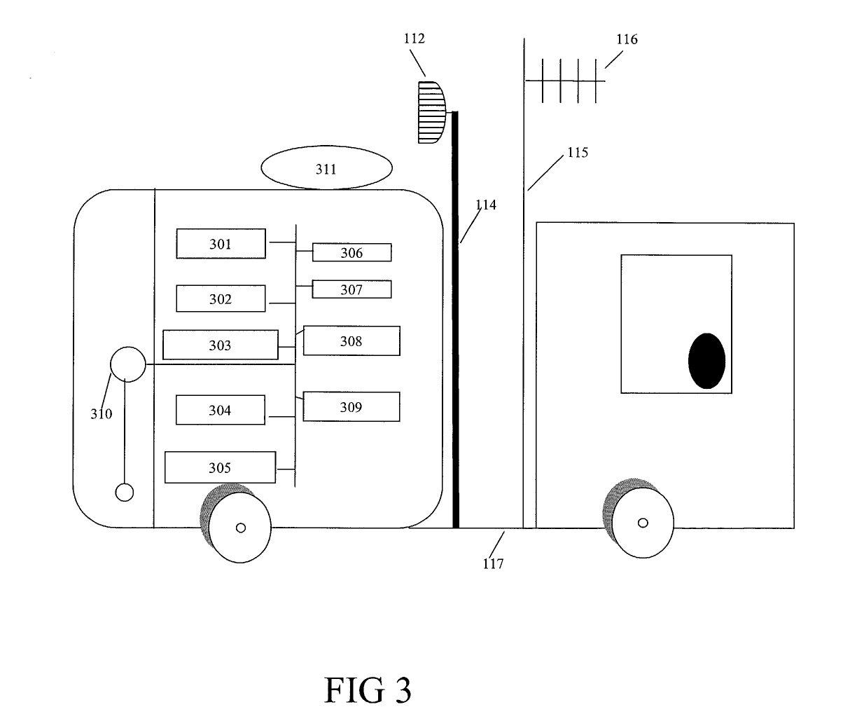

FIG. 3 illustrates in more detail an exemplary remote, self-contained cell site 117 that includes a conventional, light truck that carries and houses a radio frequency unit 301, a modem 302, a multiplexer/demultiplexer 303, a digital and/or analog signal processing unit 304, a loop-back circuit 305, a control unit 306, a database 307, a microwave radio 308, backup batteries 309, an extendible mast 114 that supports a microwave antenna 112, an extendible mast 115 that supports an radio frequency antenna 116, a generator 310, and an air conditioner 311. Additionally, components 301-310 are configured in a flexible manner such as by mounting them in racks that allows each component to be easily removed and replaced with minimal time and labor resources.

The remote, self-contained cell site functions as follows. When a conventional cell site base station is disconnected from the communications network and goes “off the air” (e.g., the T1 connection is cut), the remote, self-contained cell site 117 is mobilized. The remote, self-contained cell site 117 is positioned near or at the disconnected cell site to re-establish communications between the wireless personal communication devices 120, 121 and cell site 101. The light truck that carries the remote, self-contained cell site 117 is small enough to be placed next to the disconnected cell site and its extendable mast 114 supporting a microwave antenna 112 is raised. A second extendable mast 115 supporting a radio frequency antenna 116 is also raised. The radio frequency antenna 116 communicates signals to and from personal wireless communication devices 120, 121. The remote, self-contained cell site 117 converts the radio frequency signals to and from microwave signals and communicates these microwave signals with the communications network using a linking frequency signal 113 between microwave antenna 112 and microwave antenna 111 of a nearby remote, self-contained communications antenna unit 109 coupled (wired or wireless) to cell site 101 or to the local service provider's crossbox junction point 201. The two microwave antennas 108, 109 are aligned and connectivity with the communications network is immediately and conveniently restored. Alternatively, a connection to cell site 101 could be made using wireless communications (e.g., transceiving radio frequency signals or microwave signals) with the remote, self-contained cell site 117. For example, the microwave antenna 112 of the remote, self-contained cell site 117 could transceive signals with a microwave antenna 122 of cell site 101.

The remote, self-contained cell site is a mobile cellular system, and its components 112, 114, 115, 116, and 301-311 are easily assembled and transported on a light truck. In alternate embodiments, the remote, self-contained cell site can be mounted on a variety of conventional and non-conventional transportation vehicles, such as, for example, motorized vehicles (e.g., a car, a boat, an airplane, or a helicopter) and non-motorized vehicles (e.g., a hot-air balloon).

Further details on these embodiments, other possible embodiments, and additional methods and systems of this invention are set forth below.

The wired mediums discussed above may be a fiber, cable, or other carrier medium.

In alternate embodiments, this invention can be mounted on a variety of conventional and non-conventional transportation vehicles, such as, for example, motorized vehicles (e.g., a car, a boat, an airplane, or a helicopter) and non-motorized vehicles (e.g., a utility trailer or a hot-air balloon).

The equipment and communication methods of the remote, self-contained cell site are usable with all wireless communication products, methods, and frequencies. They are usable with cellular/PCS phones, wireless computers and modems, wireless personal data assistants, global positioning devices, and any other wireless data, voice, or video communications devices. They are usable with satellite phones and satellite communications technology. They are usable with code-division multiple access (CDMA) technologies, time-division multiple access (TDMA) technologies, the global system for mobile communications (GSM) technology, and other technologies. Further, they are usable with all frequencies in the electromagnetic spectrum and is compatible with the June 2000 World Radiocommunication Conference agreement on third-generation cellular telephony.

Additionally, the range of operation of the remote, self-contained cell site is partially a function of transmitter power, and is, therefore, a matter of choice. Antenna selection and siting is also a matter of choice. For example, omnidirectional or directional antennas can be used. Additionally, the antenna may include diversity reception of mobile signals in various embodiments of this invention. Further, linking frequency signal 113 may be in the microwave or other communications band and is the medium over which the remote, self-contained cell site communicates with a cellular system connected to the communications network.

In another embodiment, the channels assigned to the remote, self-contained cell site are allocated such it has the appearance of an additional “on the air” cell site to the wireless communication network. In this way, a sector may be subdivided. Such subdivisions significantly increase the capacity of the wireless communications system. This invention accomplishes such subdivision at a minimum cost without the need to add a cell site and provides the functionality of an additional cell site.

In other various embodiments, the remote, self-contained cell site includes other useful components. For example, the truck platform used to transport the remote, self-contained cell site includes stabilizing equipment, such as a hydraulic jack to provide improved platform stability. Another example is that the mast of the remote, self-contained cell site may be a telescopic mast that quickly and easily allows the mast to be extended and collapsed.

Various embodiments of the invention have been described in fulfillment of the various objects of the invention. It should be recognized that these embodiments are merely illustrative of the principles of this invention. Numerous modifications and adaptations thereof will be readily apparent to those skilled in the art without departing from the spirit and scope of this invention.

What is claimed is:

1. A remote, self-contained cell site apparatus for establishing wireless communications, comprising:
(a) a vehicle; and
(b) attached to said vehicle, equipment for
(i) transceiving wireless communication signals between said equipment and a wireless device, and
(ii) transceiving wireless communication signals between said equipment and a communications network.

2. The apparatus of claim 1, wherein said wireless communication signals between said equipment and said wireless device are transceived at 806-960 MHz.

3. The apparatus of claim 1, wherein said wireless communication signals between said equipment and said wireless device are transceived at 1710-1855 MHz.

4. The apparatus of claim 1, wherein said wireless communication signals between said equipment and said wireless device are transceived at 2500-2690 MHz.

5. The apparatus of claim 1, wherein said wireless communication signals between said equipment and said wireless device are transceived at 2.4-2.5 GHz.

6. The apparatus of claim 1, wherein said wireless communication signals between said equipment and said wireless device are for wireless paging devices.

7. The apparatus of claim 1, wherein said wireless communication signals between said equipment and said wireless device are for digital processing devices.

8. The apparatus of claim 1, wherein said wireless communication signals between said equipment and said wireless device comprise any frequency signal in the electromagnetic spectrum.

9. The apparatus of claim 1, wherein said wireless communication signals between said equipment and said communications network are transceived at 806-960 MHz.

10. The apparatus of claim 1, wherein said wireless communication signals between said equipment and said communications network are transceived at 1710-1855 MHz.

11. The apparatus of claim 1, wherein said wireless communication signals between said equipment and said communications network are transceived at 2500-2690 MHz.

12. The apparatus of claim 1, wherein said wireless communication signals between said equipment and said communications network are transceived at 2.4-2.5 GHz.

13. The apparatus of claim 1, wherein said wireless communication signals between said equipment and said communications network comprise any frequency signal in the electromagnetic spectrum.

14. The apparatus of claim 1, wherein said communications network comprises a celestial communications network.

15. The apparatus of claim 1, wherein said communications network comprises a terrestrial communications network.

16. The apparatus of claim 15, wherein said terrestrial communications network comprises a public switch telephone network.

17. The apparatus of claim 1, wherein said equipment comprises one or more of the following:
(a) a power source for providing power to said remote, self-contained cell site apparatus;
(b) a backup power source for providing backup power to said remote, self-contained cell site apparatus;
(c) a charging source for
(1) charging said power source, and
(2) charging said backup power source;
(d) transceiving equipment for
(i) transmitting and receiving said wireless communication signals between said equipment and said wireless device, and
(ii) transmitting and receiving said wireless communication signals between said equipment and said communications network;
(e) network interface equipment for
(i) processing said wireless communication signals between said equipment and said wireless device, and
(ii) processing said wireless communication signals between said equipment and said communications network;
(f) a control unit for
(i) managing said wireless communication signals between said equipment and said wireless device, and
(ii) managing said wireless communication signals between said equipment and said communications network;
(g) a data storage unit for storing data associated with
(i) said wireless communication signals between said equipment and said wireless device, and
(ii) said wireless communication signals between said equipment and said communications network;
(h) a mast for extending and collapsing an antenna of said transceiving equipment;
(i) environmental control equipment for controlling temperature; and
(j) stabilizing equipment to secure and balance the attachment of said equipment to said vehicle.

18. The apparatus of claim 17, wherein said control unit comprises a personal computer.

19. The apparatus of claim 17, wherein said vehicle comprises a motorized vehicle.

20. The apparatus of claim 19, wherein said charging source further charges said motorized vehicle.

21. The apparatus of claim 19, wherein said motorized vehicle comprises a truck.

22. The apparatus of claim 17, wherein said vehicle comprises a non-motorized vehicle.

23. The apparatus of claim 17, wherein said mast is an extendible mast.

24. The apparatus of claim 1, wherein said remote, self-contained communications antenna unit communicates with a conventional cell site using a wired medium.

25. The apparatus of claim 1, wherein said remote, self-contained communications antenna unit is coupled with a cellular switch of said communications network.

26. The apparatus of claim 1, wherein said remote, self-contained communications antenna unit communicates with a conventional cell site using wireless communications.

27. The apparatus of claim 1, wherein said wireless device comprises one of the following:
(a) a phone;
(b) a computer;
(c) a modem;
(d) a pager;
(e) a personal data assistant;
(f) a global positioning system receiver; and
(g) an interactive television.

28. A method for establishing wireless communications, comprising:
(a) transceiving wireless communication signals between a wireless device and a remote, self-contained cell site apparatus; and
(b) transceiving wireless communication signals between said remote, self-contained cell site apparatus and a remote, self-contained communications antenna unit coupled with a cell site; and
(c) transceiving wireless communication signals between said cell site and a communications network.

29. A method for establishing wireless communications, comprising:
(a) transceiving wireless communication signals between a wireless device and a remote, self-contained cell site apparatus;
(b) transceiving wireless communication signals between said remote, self-contained cell site apparatus and a remote, self-contained communications antenna unit coupled with a cellular switch; and
(c) transceiving communication signals between said remote, self-contained communications antenna unit and a communications network.

30. A method for wireless communications using a remote, self-contained cell site comprising:
(a) transceiving wireless communication signals between a wireless device and a remote, self-contained cell site apparatus;
(b) transceiving wireless communication signals between said remote, self-contained cell site and a cell site; and
(c) transceiving wireless communication signals between said cell site and a communications network.
